(19) United States
(12) Patent Application Publication
(10) Pub. No.: US 2024/0241805 A1
(43) Pub. Date: Jul. 18, 2024

(54) APPARATUS, COMPUTER-READABLE MEDIUM, AND METHOD FOR INCREASING MEMORY ERROR HANDLING ACCURACY

(71) Applicant: Intel Corporation, Santa Clara, CA (US)

(72) Inventors: Tao Xu, Shanghai (CN); Shijie Liu, Shanghai (CN); Kevin Yufu Li, Shanghai (CN); Lei Zhu, Shanghai (CN); Sarathy Jayakumar, Portland, OR (US)

(21) Appl. No.: 18/560,270

(22) PCT Filed: Sep. 25, 2021
(86) PCT No.: PCT/CN2021/120505

§ 371 Date: Nov. 10, 2023

(51) Int. Cl. G06F 11/20

(52) U.S. Cl. CPC G06F 11/2094; G06F 2201/85

(57) ABSTRACT

A disclosed example includes setting a corrected error threshold value for a memory rank; recording, in a corrected error bank record memory structure, corrected errors for memory banks in the memory rank; maintaining, in the corrected error bank record memory structure, counts of the corrected errors for the memory banks; and notifying runtime error handling circuitry in response to at least one of the counts of the corrected errors satisfying a threshold value.

### FIELD OF THE DISCLOSURE

This disclosure relates generally to memory error handling and, more particularly, to increasing memory error handling accuracy.

### BACKGROUND

Many modern memory controllers implement corrected error (CE) counters and thresholds per rank of memory, such as in double data rate (DDR) memory and high bandwidth memory (HBM). When a CE counter for a memory rank reaches the error threshold, the memory controller sets that memory rank's CE threshold overflow status bit and sends an interrupt to the basic input/output system (BIOS). Upon receiving the interrupt, the BIOS takes a RAS action to recover the computer system. Among the common RAS actions the BIOS can take are a post package repair (PPR) feature in memory, a partial cache line sparing (PCLS) action feature on some server platforms, adaptive double device data correction (ADDDC), and bank sparing.

### BRIEF DESCRIPTION OF THE DRAWINGS

FIG. 1 is an example schematic illustration of a memory module.

FIG. 2 is a schematic illustration of example circuitry to increase memory error handling accuracy.

FIG. 3 is a flowchart representative of example machine readable instructions that may be executed by example processor circuitry to implement BMC-based error handling at a memory bank level.

FIG. 4 is a flowchart representative of example machine readable instructions that may be executed by example processor circuitry to implement BIOS-based error handling at a memory bank level.

FIG. 5 is a flowchart representative of example machine readable instructions that may be executed by example processor circuitry to implement error handling at a memory bank level utilizing bank error counters and bank error rates.

FIG. 6 is a block diagram of an example processing platform including processor circuitry structured to execute the example machine readable instructions of FIGS. 3-5 to implement examples disclosed herein.

FIG. 7 is a block diagram of an example implementation of the processor circuitry of FIG. 6.

FIG. 8 is a block diagram of another example implementation of the processor circuitry of FIG. 6.

The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Hardware rank-level corrected error (CE) counters and CE threshold hardware have limitations on error visibility across banks. In some examples, the rank-level CE hardware support has granularity that is too rough. Specifically, in some examples, rank-level CE hardware does not indicate each memory bank's heathy status accurately. In some examples, once CE hardware threshold logic detects an error threshold limit has been reached for the rank, only the memory bank with the most recent error is known.

As used herein, a memory bank is the logical storage within computer memory that is or is typically used for storing and retrieving frequently used data. It can be a part of standard random access memory (RAM) or the cache memory used for easily accessing and retrieving program and standard data. In a computer, the memory bank may be determined by the memory controller along with physical organization of the hardware memory slots. In a typical synchronous dynamic random-access memory (SDRAM) or double data rate synchronous dynamic random-access memory (DDR SDRAM), a bank consists of multiple rows and columns of storage units, and is usually spread out across several chips, different virtual platforms or servers.

In some examples, the cost of implementing bank-level memory CE counter/threshold hardware logic in the silicon package is high. With several different forms of reliability, availability, and serviceability (RAS) memory recovery options available at the memory bank level (or another more finely grained level), a variety of CE patterns across banks will lead to a wrong bank being selected and a decrease in RAS effectiveness and efficiency.

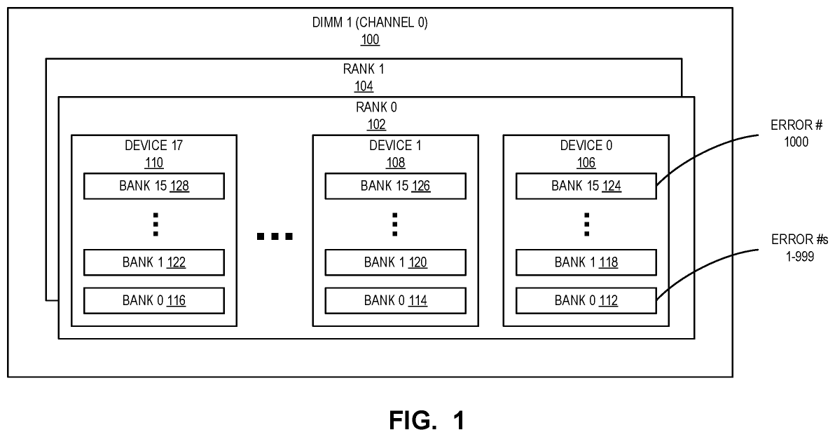

FIG. 1 is an example schematic illustration of an overview of a memory module. More specifically, an example dual inline memory module (DIMM) 100 is shown (DIMM 1 (memory channel 0)). In some examples, the DIMM 100 includes two memory ranks, rank 0 (102) and rank 1 (104). In the illustrated example, each rank includes 18 devices (e.g., device 0 (106), device 1 (108), up to device 17 (110)). In the illustrated example, rank 1 spans all 18 devices (e.g., 0-16 Gbytes). In the illustrated example, banks 0-15 span all 18 devices as well. Specifically, bank 0 (e.g., 112, 114, 116), bank 1 (e.g., 118, 120, and 122), and so on up to bank 15 (e.g., 124, 126, and 128) span all devices, including device 0 (106), device 1 (108), and so on up to device 17 (110). Additionally or alternatively, examples disclosed herein may be implemented using any other suitable number of ranks, devices, and/or banks in any other suitable configuration.

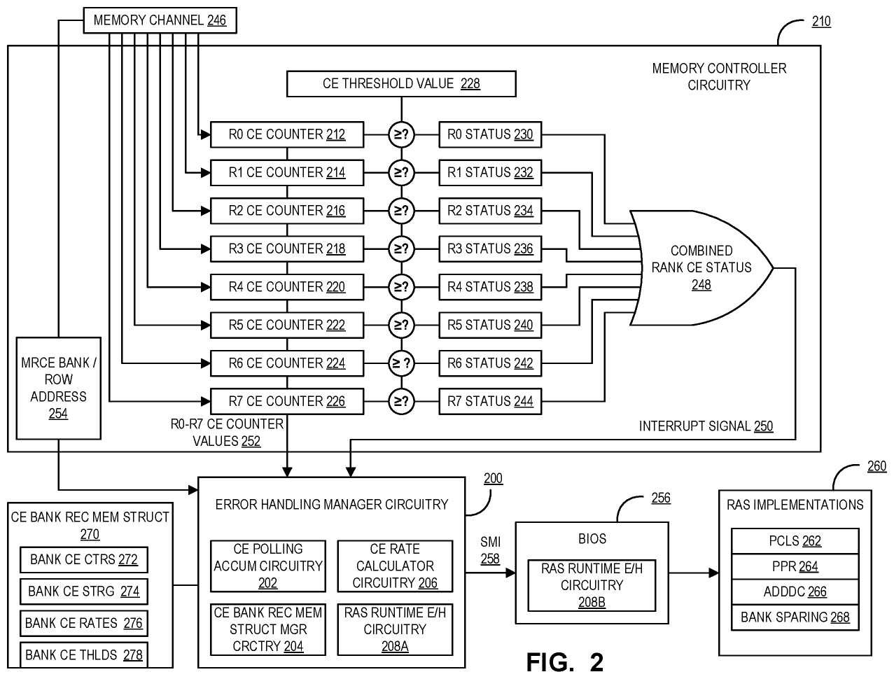

In the example illustrated in FIG. 1, a basic input/output system (BIOS) may use a bank-level adaptive double device data correction (ADDDC) when a rank CE counter (e.g., a rank CE counter 212, 214, 216, 218, 220, 222, 224, 226 of FIG. 2) reaches a rank threshold. In some examples, a standard CE rank threshold may be a count of 1000. In a standard CE rank threshold setup, the system BIOS is only aware of the memory bank that produced the last CE prior to the threshold being reached. The BIOS is not aware of the general health of each bank in the memory rank.

For example, if the CE threshold is 1000 and errors 1-999 take place in device 0 (106) bank 0 (112) but the final error occurs in device 0 (106) bank 15 (124), the BIOS does not distinguish this discrepancy. Rather, the BIOS only is aware that the last error occurred in bank 15. In the example circumstance in FIG. 1, bank 0 (112) exhibits problematic behavior, but the BIOS error handling will flag bank 15 (124) for a RAS action. In some examples, the BIOS will perform a bank-level ADDDC for bank 15 (124) even though this is not the correct action. Thus, using prior techniques of BIOS error handling, a presumably healthy bank (e.g., bank 15 (124)) has corrective action taken, and the problematic bank (e.g., bank 0 (112)) remains active in the memory subsystem and may continue to generate errors.

Prior hardware CE counter logic lacks the capability to calculate the CE rate (i.e., the number of errors over a period of time). For example, 750 CEs in a bank spread out over the course of six months for a memory rank is significantly less problematic than a ramp up of 750 CEs in a bank over the course of an hour. The latter example (750 CEs in one hour) means the bank is unstable and there is likely an imminent memory hardware failure that will require a RAS action soon. On the other hand, the former example (750 CEs spread out over 6 months), likely means the memory bank will last for several additional weeks or months prior to any required RAS corrective action.

FIG. 2 is a schematic illustration of example circuitry to increase memory error handling accuracy. In the illustrated example, error handling manager circuitry 200 is provided in a computer system that utilizes CE handling logic in the memory subsystem. The example error handling manager circuitry 200 may be implemented for a baseband management controller (BMC) and/or a processor. In the illustrated example, the error handling manager circuitry 200 includes at least one or more of CE polling accumulator circuitry 202, CE bank record memory structure manager circuitry 204, CE rate calculator circuitry 206, and RAS runtime error handling circuitry 208A.

In the illustrated example, memory controller circuitry 210 implements a hardware CE counter per memory rank (e.g., rank 0 (R0) through rank 7 (R7)). For example, the rank 0 hardware CE counter is illustrated as R0 CE counter 212 and the rank 7 hardware CE counter is illustrated as R7 CE counter 226. In the example of FIG. 2, the rank 0-7 hardware CE counters are illustrated as R0-R7 CE counters 212-226. In other examples, fewer or more rank CE counters may be provided for a different number of ranks with different memory configurations (e.g., two ranks, four ranks, 16 ranks, etc.) are provided. In some examples, the R0-R7 CE counters 212-226 are implemented in hardware registers to store count values. In other examples, the R0-R7 CE counters 212-226 are implemented in a local memory buffer or any other storage circuitry capable of storing count values.

Additionally, in some examples, a CE threshold value 228 is compared to each of the R0-R7 CE counters 212-226, per rank, and if a CE counter is equal to (or greater than in some examples) the CE threshold value 228, the respective rank 0 through rank 7 (R0-R7) status (230-244) is set to reflect that the count value of the corresponding CE counter satisfies the CE threshold value 228. In the illustrated example, each rank status (230-244) is a single bit, which would cause the respective status bit to be set for the memory rank having an error count satisfying the CE threshold value 228. In some examples, the R0-R7 status bits 230-244 are implemented in one or more hardware registers (e.g., status registers). In other examples, the R0-R7 status bits 230-244 are implemented in a local memory buffer or any other storage circuitry capable of storing the status of a rank.

In the illustrated example, when any one of the R0-R7 status bits 230-244 are set, combined rank CE status circuitry 248 in the memory controller circuitry 210 will signal an interrupt (e.g., an interrupt signal 250) to the error handling manager circuitry 200. For example, the combined rank CE status circuitry 248 logically ORs all R0-R7 status bits 230-244, thus, when at least one R0-R7 CE counter 212-226 equals/reaches the CE threshold value 228 and at least one R0-R7 status bit 230-244 is set, the combined rank CE status circuitry 248 sends the interrupt signal 250 to the error handling manager circuitry 200.

In some examples, the CE threshold value 228 is set to “1” so that if any error at all is counted in any of the R0-R7 counters 212-226, the status bit for the one or more ranks with an error is set. In other examples, the CE threshold value 228 may be set to a higher number on system start up. In some examples, a value for the CE threshold value 228 is selected as a substantially higher value so that any error correcting action waits until a rank surpasses a significant number of correctable errors (e.g., 1000 or more) to minimize the RAS action overhead. In prior implementations, the CE threshold value is normally set to a number above 1000 (e.g., 0x7FFF, 0x3FF, etc.). Thus, setting the CE threshold value 228 to a “low” value that differs from prior implementations can be defined as a value between the number 1 and up to 10% of a typical CE threshold value set in prior implementations.

In the illustrated example, a memory channel 246 that has one or more ranks provides a set of input lines to the memory controller circuitry 210 at the R0-R7 CE counters 212-226. In the illustrated example, the counters 212-226 increment each time the input lines from the memory channel 246 send a signal indicating a CE error has occurred. In other examples, the input lines from the memory channel 246 may be sideband channels or any other suitable form of byte-size or greater data input that provides the R0-R7 CE counters 212-226 with updated CE count values to represent one or more CE occurrences that occurred at substantially the same time or over an elapsed duration.

Returning to the example error handling manager circuitry 200, in some examples, in response to receiving the interrupt signal 250, the error handling manager circuitry 200 initiates one or more processes to monitor the memory channel 246 for CEs. In some examples, the CE polling accumulator circuitry 202 in the error handling manager circuitry 200 polls (e.g., accesses) the R0-R7 CE counter values 252 from corresponding ones of the CE counters 212-226. In some examples, the polling is dynamically accessed as soon as any one of the R0-R7 CE counters 212-226 is updated. In other examples, the polling process includes a request to pull the R0-R7 CE counter values 252 from the R0-R7 CE counters 212-226, prior to the CE polling accumulator circuitry 202 being provided access to the values.

In the illustrated example in FIG. 2, the error handling manager circuitry 200 includes CE bank record memory structure manager circuitry 204. In some examples, the CE bank record memory structure manager circuitry 204 creates a CE bank record memory structure 270 that stores a set of memory bank CE counters 272 representing each of the banks in the memory channel 246. In some examples, the CE bank record memory structure 270 is created in system memory at system initialization. In other examples, the CE bank record memory structure 270 is created in another memory storage location in the system (e.g., in a memory buffer, in a set of special purpose registers, in a cache, etc.). In some examples, the memory controller circuitry 210 reports out the most recent corrected error (MRCE) address including the bank and row information of the address (e.g., MRCE bank/row address 254) as well as the memory rank information. In other examples, the MRCE bank and row address 254 is provided to the BIOS 256 during runtime by the memory controller circuitry 210. In yet other examples, the latest CE address information (e.g., row, bank, rank, device, etc. as described in FIG. 1) is accessed by the error handling manager circuitry 200 in any way implementable by the CE processes in the memory subsystem.

In the illustrated example, the address (as well as other CE information) of each reported CE from the memory channel 246 is stored in the CE bank record memory structure 270 in bank CE storage 274. In some examples, the full address is recorded in the CE bank record memory structure 270. In other examples, only a portion of the address is recorded in the CE bank record memory structure 270, such as the bank information or the bank and row information. In the illustrated example, the CE polling accumulator circuitry 202 increments a count in the stored bank CE counter 272 within the CE bank record memory structure 270 representing the bank of memory reporting the error (e.g., one of banks 0-15 from FIG. 1). In the illustrated example, the specific bank of memory is derived from the MRCE bank/row address information 254. In some examples, the CE polling accumulator circuitry 202 receives an update to the R0-R7 CE counter values 252 (i.e., a new CE error has been reported because one of the R0-R7 CE counters 212-226 has been incremented) and in response triggers the recording of the CE bank address in the CE bank record memory structure 270 and increments the bank CE counter 274 representing the bank of the CE address.

In the illustrated example, each recorded (e.g., stored) CE in the CE bank record memory structure 270 (specifically in bank CE storage 274) also includes a timestamp associated with the time the CE is recorded. In the illustrated example, the CE rate calculator circuitry 206 monitors a dynamic rate of CEs per bank over time. In the illustrated example, the time window may be a number of CEs per second, per minute, per hour, per day, etc. for each memory bank. Thus, in the illustrated example, the CE rate calculator circuitry 206 designates a portion of the CE bank record memory structure 270 to store a dynamic CE rate per memory bank (e.g., bank CE rates 276). In the illustrated example, the CE rate calculator circuitry 206 designates a portion of the CE bank record memory structure 270 to store one or more CE bank rate threshold values (e.g., bank CE thresholds 278) to compare against the bank CE rates 276. In other examples, the CE rate calculator circuitry 206 utilizes a series of registers or another storage structure to store the CE rate information per bank.

In the illustrated example, the CE rate calculator circuitry 206 updates the CE rate per bank immediately each time a new CE arrives. In the illustrated example, when a CE rate for a given bank exceeds a CE rate threshold, the CE rate calculator circuitry 206 sends an interrupt to the RAS runtime error handling circuitry 208A in the error handling manager circuitry 200. In some examples, the CE rate for a given bank is an average rate over a most recent designated number of errors so as not to trigger the interrupt automatically if only, for example, two errors occur back-to-back.

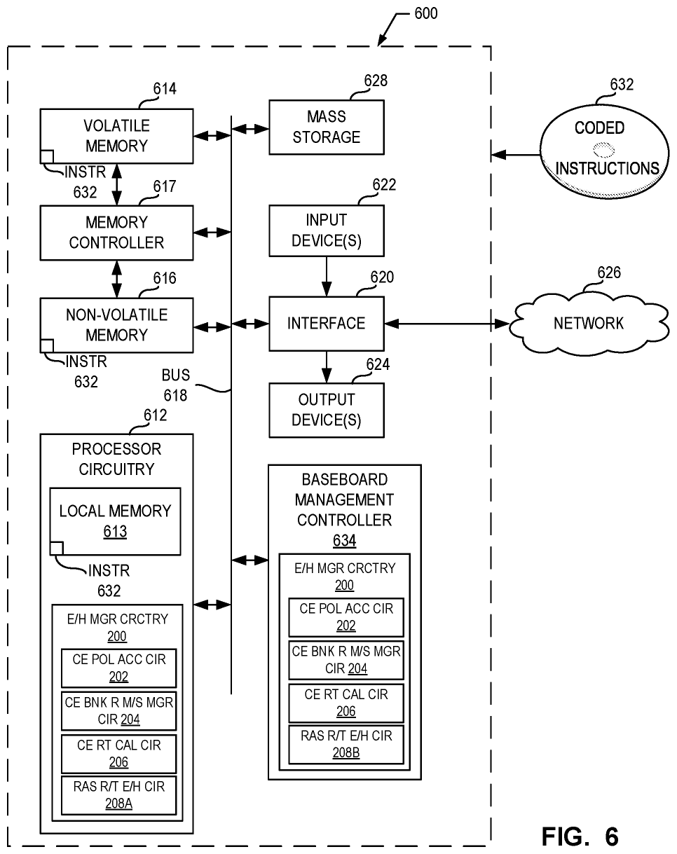

Although, the RAS runtime error handling circuitry 208A is shown implemented in the error handling manager circuitry 200 in other, in other examples, the RAS runtime error handling circuitry 208A is implemented in the BIOS 256 (which is executed in the processor circuitry), which is represented in FIG. 2 as RAS runtime error handling (E/H) circuitry 208B. In some examples, the RAS runtime error handling circuitry 208A, 208B may be implemented partially in the error handling manager circuitry 200 and partially in the BIOS 256. In some examples, the RAS runtime error handling circuitry 208A, 208B may be implemented in hardware alone, or in a combination of hardware and software and/or firmware. For example, the RAS runtime error handling circuitry 208B in the BIOS 256 may be implemented as software and/or firmware executed by processor circuitry. In this disclosure, the RAS runtime error handling circuitry 208A, 208B may be referred to generally as RAS runtime error handling circuitry 208. Unless indicated otherwise, either of the RAS runtime error handling circuitry 208A or the RAS runtime error handling circuitry 208B or any combination of the RAS runtime error handling circuitry 208A and the RAS runtime error handling circuitry 208B may be used to implement aspects disclosed in connection with the RAS runtime error handling circuitry 208. A more detailed description of the BMC and processor circuitry are described in the discussion of FIG. 6 below.

In the illustrated example, the RAS runtime error handling circuitry 208 accesses the CE bank error count information maintained in the CE bank record memory structure and the CE rate information maintained by the CE rate calculator circuitry 206. This CE information provides details that allow for accurate CE bank-level stability knowledge, which can be utilized to target specific memory banks that are unstable with RAS actions. Additionally, the CE rate information allows for predicted future timelines of when specific memory banks may be designated as needing replacement. This predictive information may allow for a RAS action to replace certain memory banks with spare memory banks prior to one or more uncorrectable errors that would cause a fault and an inefficient system recovery.

In the illustrated example, the RAS runtime error handling circuitry 208A sends a system management interrupt (SMI) 258 to the BIOS 256 when a RAS action is to take place. In the illustrated example, the BIOS 256 initiates a RAS action/implementation 260 for the affected memory bank upon receiving the request, such as PCLS 262, PPR 264, ADDDC 266, or bank sparing 268.

Although the example error management techniques disclosed herein are described in connection with memory banks, in other examples the disclosed error management techniques may be utilized at a more finely grained address level, such as at the memory row level or another level as needed.

In some examples, the error handling manager circuitry 200 is a portion of a processor circuitry. In such some examples, the processor circuitry is a general purpose central processing unit (CPU), a fixed programmable gate array (FPGA), or another type of processor. Example processor circuitry is discussed in greater detail below in relationship to FIG. 6.

In some examples, the error handling manager circuitry 200 is a portion of a baseboard management controller (BMC) circuitry. In such some examples, the BMC is a specialized processor for monitoring and management of a host system that includes one or more CPUs and memory.

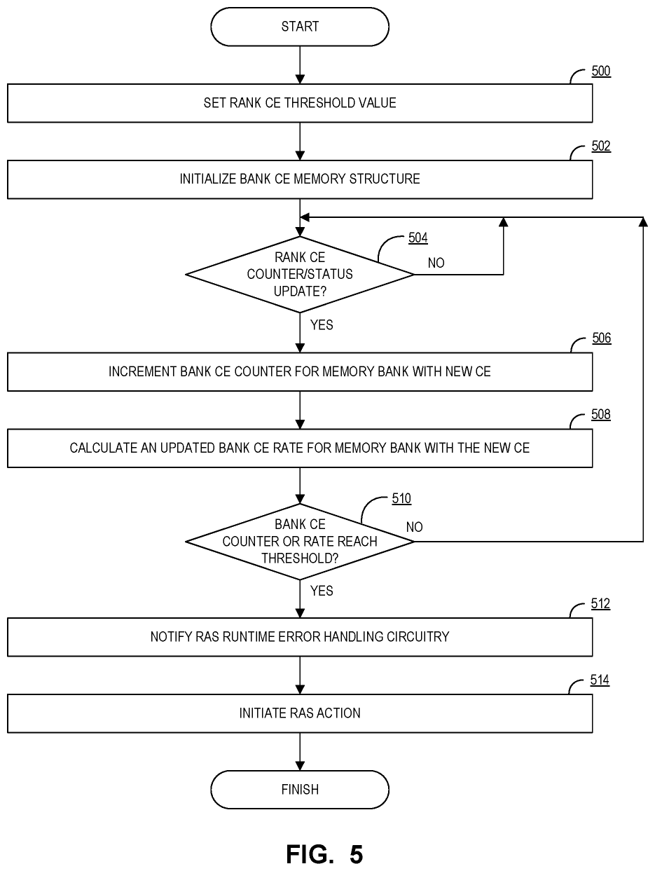

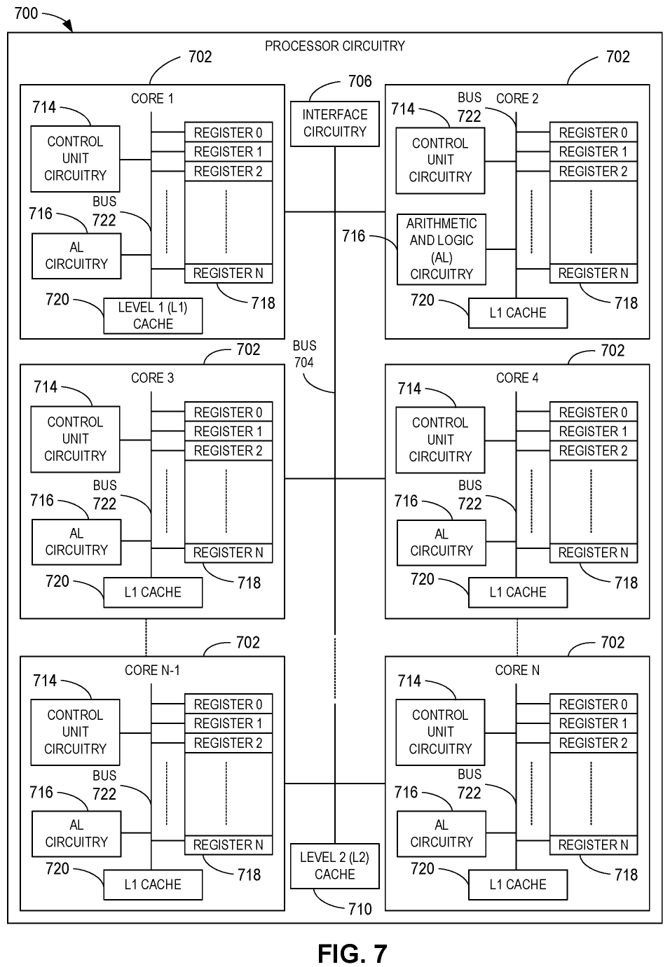

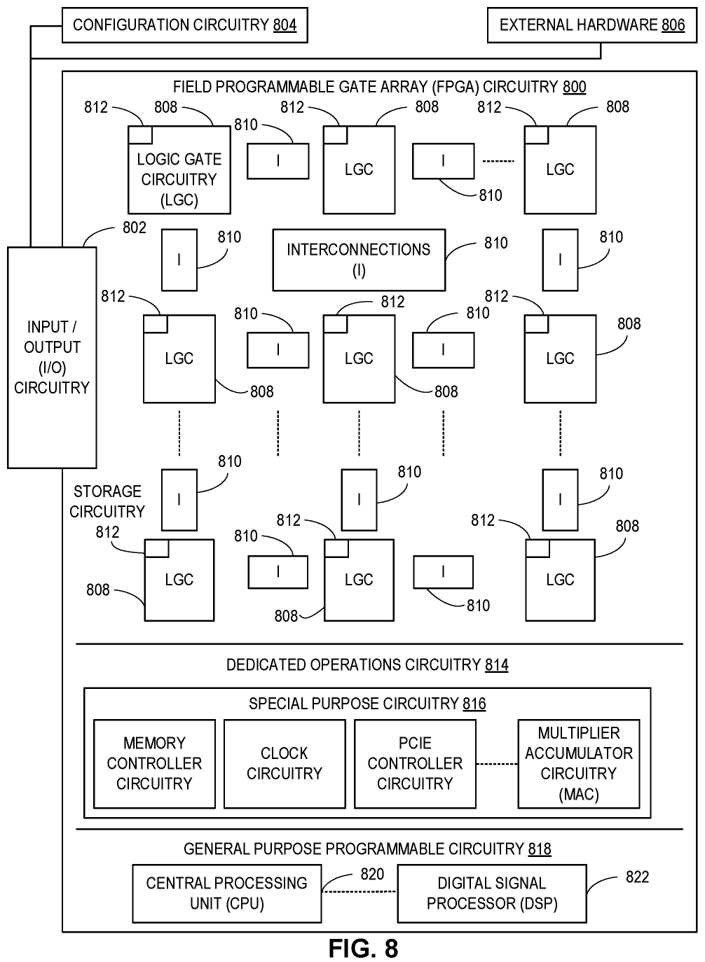

In some examples, the error handling manager circuitry 200 includes means for managing a CE bank record memory structure (e.g., the CE bank record memory structure 270 of FIG. 2). For example, the means for managing the CE bank record memory structure may be implemented by the CE bank record memory structure manager circuitry 204 of FIG. 2. In some examples, the CE bank record memory structure manager circuitry 204 may be implemented by machine executable instructions such as that implemented by at least blocks 502, 506, 510, 512 of FIG. 5 executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the CE bank record memory structure manager circuitry 204 is implemented by other hardware logic circuitry, hardware implemented state machines, and/or any other combination of hardware, software, and/or firmware. For example, the CE bank record memory structure manager circuitry 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the error handling manager circuitry 200 includes means for monitoring one or more rank CE count values (e.g., rank CE count values in the rank CE counters 212-226 of FIG. 2). For example, the means for monitoring one or more rank CE count values may be implemented by the CE polling accumulator circuitry 202 of FIG. 2. In some examples, the CE polling accumulator circuitry 202 may be implemented by machine executable instructions such as that implemented by at least block 504 of FIG. 5 executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the CE polling accumulator circuitry 202 is implemented by other hardware logic circuitry, hardware implemented state machines, and/or any other combination of hardware, software, and/or firmware. For example, the CE polling accumulator circuitry 202 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the error handling manager circuitry 200 includes means for monitoring one or more CE rate values (e.g., CE rate values in the bank CE rate locations 276 of FIG. 2). For example, the means for monitoring one or more CE rate values may be implemented by the CE rate calculator circuitry 206 of FIG. 2. In some examples, the CE rate calculator circuitry 206 may be implemented by machine executable instructions such as that implemented by at least blocks 508, 510, 512 of FIG. 5 executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the CE rate calculator circuitry 206 is implemented by other hardware logic circuitry, hardware implemented state machines, and/or any other combination of hardware, software, and/or firmware. For example, the CE rate calculator circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the error handling manager circuitry 200 includes means for error handling (e.g., performing corrective action such as a RAS action). For example, the means for error handling may be implemented by the RAS runtime error handling circuitry 208 of FIG. 2. In some examples, the RAS runtime error handling circuitry 208 may be implemented by machine executable instructions such as that implemented by at least block 514 of FIG. 5 executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the RAS runtime error handling circuitry 208 is implemented by other hardware logic circuitry, hardware implemented state machines, and/or any other combination of hardware, software, and/or firmware. For example, the RAS runtime error handling circuitry 208 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the BMC/processor error handling manager circuitry 200 is illustrated in FIG. 2, one or more of the elements, processes, and/or devices illustrated in FIG. 2 may be combined, divided, re-arranged, omitted, eliminated, and/or implemented in any other way. Further, the example CE polling accumulator circuitry 202, the example CE bank record memory structure manager circuitry 204, the example CE rate calculator circuitry 206, and the example RAS runtime error handling circuitry 208, and/or more specifically, the error handling manager circuitry 200 of FIG. 2 may be implemented by hardware alone or by hardware in combination with software and/or firmware. Thus, for example, any of the example BMC/processor error handling manager circuitry 200, and/or more specifically, the example CE polling accumulator circuitry 202, the example CE bank record memory structure manager circuitry 204, the example CE rate calculator circuitry 206, and the example RAS runtime error handling circuitry 208 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example error handling manager circuitry 200, and/or more specifically, the CE polling accumulator circuitry 202, the CE bank record memory structure manager circuitry 204, the CE rate calculator circuitry 206, and the RAS runtime error handling circuitry 208 may include one or more elements, processes, and/or devices in addition to, or instead of, those illustrated in FIG. 2, and/or may include more than one of any or all of the illustrated elements, processes and devices.

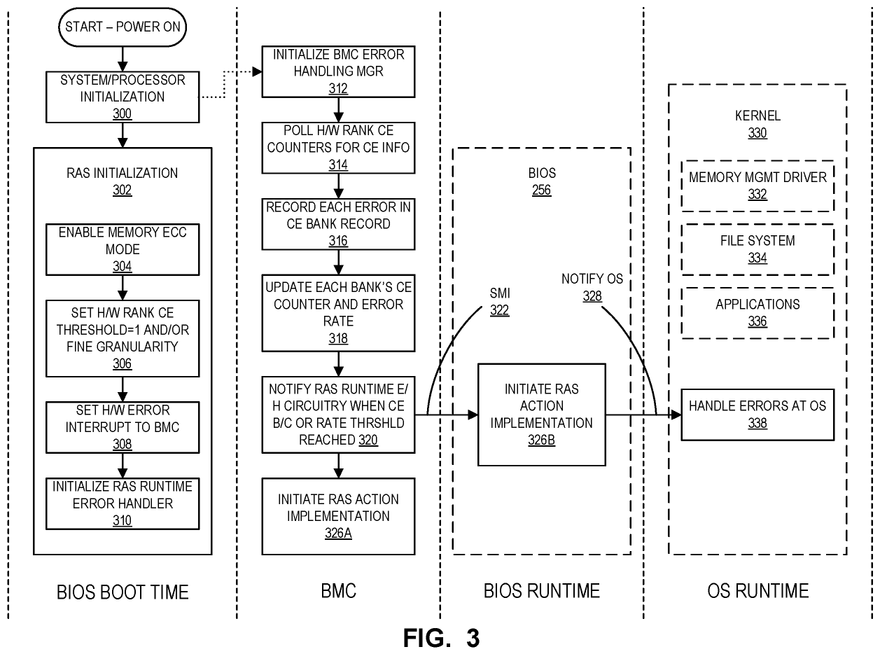

Flowcharts representative of example hardware logic circuitry, machine readable instructions, hardware implemented state machines, and/or any combination thereof for implementing the example error handling manager circuitry 200 are shown in FIGS. 3-5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The programs may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3-5, many other methods of implementing the example error handling manager circuitry 200 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3-5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions that may be executed by example processor circuitry to implement BMC-based error handling at a memory bank level. The example instructions of FIG. 3 are described in connection with example BMC circuitry 634 of FIG. 6. In some examples, the process flow is performed by both the error handling manager circuitry 200 (FIG. 2) and processor circuitry 612 (FIG. 6).

In the illustrated example of FIG. 3, when power is supplied to the computer system, the process begins. The first section of processing blocks happen at BIOS boot time, which the processor circuitry 612 (FIG. 6) performs.

At block 300, the example processor circuitry 612 initializes the processor at boot up. In the illustrated example, as part of the initialization, at block 302, the processor circuitry 612 boots the BIOS and initializes the RAS capabilities in the computer system. In the RAS initialization 302, at block 304, the processor circuitry 612 enables a memory error checking and correction (ECC) mode in the system.

At block 306, the example processor circuitry 612 sets the rank CE threshold value 228 (FIG. 2) to one. In other examples, the processor circuitry 612 sets the rank CE threshold value 228 to a low value, such as a number that is at or below 10% of a BIOS standard value implemented in prior techniques. In the illustrated example, the processor circuitry 612 sets the granularity of the CE addresses being tracked and may change the granularity to a finer location distinction, such as tracking CEs to individual rows of memory instead of to banks of memory.

At block 308, the example processor circuitry 612 sets a hardware error interrupt for memory errors to the BMC circuitry 634. For example, when an EC happens, an interrupt takes place and the interrupt notification is provided to circuitry to handle the interrupt. In this example, the interrupt is sent to the BMC circuitry 634 for memory error handling duties.

At block 310, the example processor circuitry 612 initializes the RAS runtime error handler circuitry 208 (FIG. 2).

In the illustrated flowchart in FIG. 3, a second set of processing blocks is performed by the example BMC circuitry 634 (FIG. 6). At block 312, the example BMC circuitry 634 initializes the BMC error handling manager circuitry 200 (FIG. 2). In some examples, the timing of when the BMC processing blocks column are performed are not fully dependent upon the processor circuitry 612 completing all BIOS boot time blocks (e.g., block 300 and blocks of the RAS initialization 302). For example, at system/processor initialization, block 300, the example BMC circuitry 634 can begin initializing the error handling manager circuitry 200 (block 312). In some examples, as part of the BMC error handling manager initialization, the BMC circuitry 634 allocates a memory structure 270 (FIG. 2) to store a set of bank CE counters and one or more bank CE thresholds.

At block 314, the example BMC circuitry 634 polls the hardware rank CE counters in the memory controller circuitry 210 for new CE information. In some examples, the CE information is a CE count per memory rank. In some examples, the BMC circuitry 634 actively polls the rank CE counters 212-226 (e.g., reads each counter). In other examples, the BMC circuitry 634 receives rank CE counter information from the memory controller circuitry 210 when a rank CE counter is updated.

At block 316, the example BMC circuitry 634 records (e.g., stores) each new CE in a CE bank record memory structure 270. In some examples, the stored information for the CE may include the address and the timestamp of the CE.

At block 318, the example BMC circuitry 634 updates each memory bank's recorded CE bank count and CE rate. In some examples, for each CE that is received, the counter for the bank the CE occurred within is incremented and the CE rate for that bank is calculated/recalculated. For example, the bank CE counters 272 (FIG. 2) in the CE bank record memory structure 270 (FIG. 2) may store a CE bank count per memory bank in the computer system.

In the illustrated example, at block 320, the example BMC circuitry 634 notifies the RAS runtime error handling circuitry 208 when the CE bank count or CE rate of a given CE bank has been reached. In the illustrated example, the example BMC circuitry 634 notifies the RAS runtime error handling circuitry 208A internally within the BMC circuitry 634. In other examples, the example BMC circuitry 634 notifies the RAS runtime error handling circuitry 208B running in the BIOS 256 (e.g., the processor circuitry 612 running/executing the BIOS 256). In either situation, the RAS runtime error handling circuitry 208 receives the notification and, at block 326 (A/B), depending on the location of the RAS runtime error handling circuitry 208 A or B, the example BMC circuitry 634 or the example processor circuitry 612 initiates a RAS action implementation.

In the illustrated example, at BIOS runtime, the BIOS 256 operates as a low-level executable shell in the processor. In some examples, the processor circuitry 612 receives SMIs sent to the BIOS 256 and can send communications (e.g., notifications) to the operating system (OS) running in a higher level executable shell in the processor. In some examples, at block 326B, the processor circuitry 612 sends a notification 328 to the OS regarding the RAS action being implemented to inform the OS that remediation that could include a system reinitialization is pending, among other notifications.

In the illustrated example, at OS runtime, the example processor circuitry 612 executes/runs an OS kernel 330 that operates a memory management driver 332, a file system 334, and a number of applications 336. In the illustrated example, at block 338, the example processor circuitry 612, through the OS kernel 330, receives a notification 328 of a RAS action being implemented and performs one or more OS kernel error handling procedures. In some examples, this includes OS responsibilities in response to the RAS action by way of saving information in the file system 334 and notifying any applications 336 that may be affected. At this point the process flow of FIG. 3 ends.

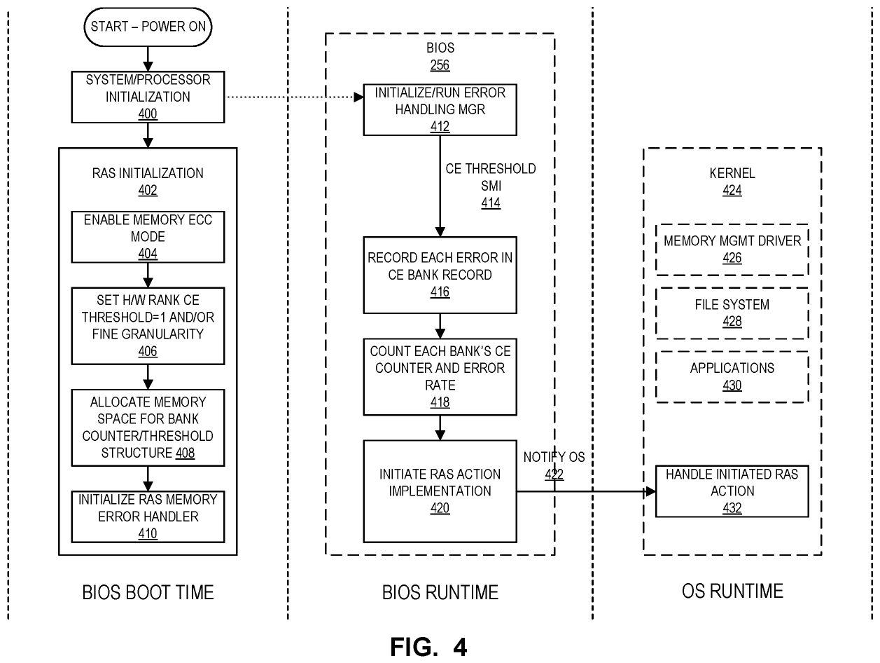

FIG. 4 is a flowchart representative of example machine readable instructions that may be executed by example processor circuitry to implement BIOS-based error handling at a memory bank level. In some examples, the process flow is performed by the processor circuitry 612 (FIG. 6).

In the illustrated example of FIG. 4, when power is supplied to the computer system, the process begins. The first section of processing blocks happen at BIOS boot time.

At block 400, the processor circuitry 612 initializes the processor at boot up. In some examples, as part of the initialization, at block 402, the processor circuitry 612 boots the BIOS and initializes the RAS capabilities in the system. In the RAS initialization 402, at block 404, the example processor circuitry 612 enables the memory error checking and correction (ECC) mode in the computer system.

At block 406, the example processor circuitry 612 sets the rank CE threshold value 228 (FIG. 2) to one. In other examples, the processor circuitry 612 sets the rank CE threshold value 228 to a low value, such as a number that is at or below 10% of a standard value implemented in prior techniques. In some examples, the processor circuitry 612 sets the granularity of the CE addresses being tracked and may change the granularity to a finer location distinction, such as tracking CEs to individual rows of memory instead of to banks of memory.

At block 408, the example processor circuitry 612 allocates memory space for a memory structure storing a set of CE bank counters, a CE storage space for the CE information, a CE bank counter threshold value, a set of CE bank rates, and a CE bank rate threshold value. For example, the bank CE counters 272 (FIG. 2) in the CE bank record memory structure 270 (FIG. 2) may store a bank counter per memory bank in the computer system.

At block 410, the example processor circuitry 612 initializes the RAS runtime error handler circuitry 208 (FIG. 2).

At block 412, the example BMC circuitry 634 initializes the error handling manager circuitry 200 (FIG. 2). In some examples, the timing of when the BIOS runtime processing blocks column are performed are not fully dependent upon the processor circuitry 612 completing all BIOS boot time blocks (e.g., block 300 and blocks of the RAS initialization 302). For example, at system/processor initialization, block 400, the example processor circuitry 612 can begin initializing the error handling manager circuitry (block 412) that is run in the BIOS 256. In some examples, once the error handling manager circuitry 200 detects a rank CE occurrence, the processing circuitry 612 generates a rank CE threshold SMI 414 in the BIOS 256.

At block 416, the example processor circuitry 612 records (e.g., stores) each new CE in the CE bank record memory structure 270. In some examples, the stored information for the CE may include the address and the timestamp of the CE.

At block 418, the example processor circuitry 612 updates each memory bank's recorded CE bank count and CE rate. In some examples, for each CE that is received, the bank CE counter (e.g., a specific counter for the bank stored in the bank CE counters 272 (FIG. 2) in the CE bank record memory structure 270 (FIG. 2)) for the bank the CE occurred within is incremented and the CE rate for that bank is calculated/recalculated.

In the illustrated example, at block 420, the example processor circuitry 612 initiates a RAS action implementation.

In the illustrated example, at BIOS runtime, the BIOS 256 is operating as a low-level executable shell in the processor. In some examples, the processor circuitry 612 sends communications (e.g., notifications) to the operating system (OS) running in a higher level executable shell in the processor. In some examples, the processor circuitry 612 sends a notification 422 to the OS regarding the RAS action being implemented to inform the OS that remediation that could include a system reinitialization is pending, among other notifications.

In the illustrated example, at OS runtime, the example processor circuitry 612 executes/runs an OS kernel 424 that operates a memory management driver 426, a file system 428, and a number of applications 430. At block 432, the example processor circuitry 612, through the OS kernel 424, receives a notification 422 of a RAS action being implemented and performs one or more OS kernel error handling procedures. In the illustrated example, this includes OS responsibilities in response to the RAS action by way of saving information in the file system 428 and notifying any applications 430 that may be affected. At this point the process flow of FIG. 4 ends.

FIG. 5 is a flowchart representative of example machine readable instructions that may be executed by example processor circuitry to implement error handling at a memory bank level utilizing bank error counters and bank error rates. In some examples, the process flow is performed by the processor circuitry 612 (FIG. 6) and BMC circuitry 634 (FIG. 6).

At block 500, the process begins by the example processor circuitry 612 setting the rank CE threshold value 228 (FIG. 2).

At block 502, the process continues by the example processor circuitry 612 initializing the CE bank record memory structure 270 (FIG. 2). In other examples, at block 502 the example BMC circuitry 634 initializes the CE bank record memory structure 270. In some examples, the BMC circuitry 634 initializes the CE bank record memory structure 270 when the error handling manager circuitry 200 is implemented in the BMC circuitry 634. In other examples, the processor circuitry 612 initializes the CE bank record memory structure 270 regardless of whether the processor circuitry 612 runs the error handling management through the BIOS or the BMC circuitry 634 runs the error handling manager circuitry 200. In some examples, the CE bank record memory structure manager circuitry 204 (FIG. 2) implements block 502 to initialize the CE bank record memory structure 270.

At block 504, the example processor circuitry 612 determines whether one of the rank CE counters 212-226 (FIG. 2) was updated (e.g., the CE status bit 230-244 (FIG. 2) of any rank has been changed/set, which can be determined by checking the combined rank CE status 248 (FIG. 2)). If the rank status bits 230-244 have not changed, then no new CE errors have occurred and the example processor circuitry 612 can return to poll the rank status again. In other examples, the BMC circuitry 634 determines whether one of the rank CE counters 212-226 was updated (e.g., the CE status bit 230-244 of any rank has been changed/set, which, again, can be determined by checking the combined rank CE status 248 (FIG. 2)). In some examples, the CE polling accumulator circuitry 202 (FIG. 2) implements block 504 to poll the rank CE counters 212-226 and determine whether any of the rank CE counters 212-226 has been updated.

If the combined rank CE status 248 of any memory rank R0-R7 (212-226) has changed, in the illustrated example, at block 506, the example processor circuitry 612 increments the bank CE counter (e.g., one of the bank CE counters 272 of FIG. 2) representing the corresponding memory bank (e.g., a specific bank counter for the affected memory bank). While the hardware rank CE status bits report the error has taken place, the recording of the error is specific to a memory bank. In some examples, the example processing circuitry 612 records the new CE information in the CE bank record memory structure 270 (FIG. 2). In other examples, the example BMC circuitry 634 records the new CE information in the CE bank record memory structure 270. In some examples, block 506 is implemented by the CE bank record memory structure manager circuitry 204 to increment or record a count value in one of the bank CE counters 272 for the memory bank in which the error occurred.

At block 508, the example processor circuitry 612 calculates an updated bank CE rate for the memory bank with the new CE. In other examples, the example BMC circuitry 634 calculates the updated bank CE rate (stored per bank in a bank CE rate memory 276 (FIG. 2)) for the memory bank with the new CE. In some examples, block 508 is implemented by the CE rate calculator circuitry 206 to calculate and/or update the bank CE rate for the memory bank with the new CE. For example, the CE rate calculator circuitry 206 may calculate and/or update a bank CE rate value and store the bank CE rate value in a corresponding one of the bank CE rate locations 276.

At block 510, the example processor circuitry 612 compares the bank CE counter value (e.g., a specific counter for the bank stored in the bank CE counters 272 (FIG. 2) in the CE bank record memory structure 270 (FIG. 2)) to a bank CE threshold value stored in a bank CE thresholds memory 278 (FIG. 2). The example processor circuitry 612 additionally compares the bank CE rate stored per bank in the bank CE rate memory 276 (FIG. 2) (e.g., the number of CEs occurring in a given amount of time) with a bank CE rate threshold value also stored in the bank CE thresholds memory 278 (FIG. 2). If the comparisons indicate neither the bank CE counter value (stored per bank in bank CE counters 272) nor the bank CE rate (stored per bank in a bank CE rate memory 276) have reached their respective thresholds, then the example processor circuitry 612 returns to block 504. In some examples, the BMC circuitry 634 performs the comparisons instead of the processor circuitry 612. In some examples, the CE bank record memory structure manager circuitry 204 implements at least a portion of block 510 to compare the bank CE counter value of one of the bank CE counters 272 to the bank CE threshold value in the bank CE thresholds memory 278. In some examples, the CE rate calculator circuitry 206 may implement at least another portion of block 510 to compare the bank CE rate from the bank CE rate memory 276 to the bank CE rate threshold value also stored in the bank CE thresholds memory 278. In other examples, the CE bank record memory structure manager circuitry 204 performs both comparisons (e.g., the comparison of the bank CE counter value to the bank CE threshold value and the comparison of the bank CE rate to the bank CE rate threshold value).

If the comparisons indicate at least one of the bank CE counter value or the bank CE rate has reached its respective threshold, then the example processor circuitry 612 notifies the RAS runtime error handling circuitry of the threshold being reached at block 512. In some examples, the BMC circuitry 634 notifies the RAS runtime error handling circuitry 208 of the threshold being reached at block 512. In some examples, the CE bank record memory structure manager circuitry 204 implements block 512 to notify the RAS runtime error handling circuitry 208. In other examples, the CE rate calculator circuitry 206 implements block 512 to notify the RAS runtime error handling circuitry 208.

At block 514, the example processor circuitry 612 initiates a RAS action to take corrective measure for the unstable memory bank(s). In some examples, the RAS runtime error handling circuitry 208 implements block 514 to perform the RAS action. For example, the RAS runtime error handling circuitry 208 may perform the RAS action by replacing one or more memory banks with one or more spare memory banks (e.g., before the occurrence of one or more uncorrectable errors that would cause a fault and/or an inefficient system recovery). At this point the process illustrated in FIG. 5 ends.

FIG. 6 is a block diagram of an example processor platform 600 structured to execute and/or instantiate the machine readable instructions and/or operations of FIGS. 3-5 to implement the apparatus of FIG. 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs microprocessors, CPUs, GPUs, DSPs, and/or microcontrollers from any desired family or manufacturer. The processor circuitry 612 may be implemented by one or more semiconductor based (e.g., silicon based) devices. In the illustrated example, the processor platform 600 is also provided with the BMC circuitry 634. In some examples, the processor circuitry 612 implements the error handling manager circuitry 200 of FIG. 2 including the example CE polling accumulator circuitry 202, the example CE bank record memory structure manager circuitry 204, the example CE rate calculator circuitry 206, and the example RAS runtime error handling circuitry 208. In other examples, the example BMC 634 implements the error handling manager circuitry 200 of FIG. 2 including the example CE polling accumulator circuitry 202, the example CE bank record memory structure manager circuitry 204, the example CE rate calculator circuitry 206, and the example RAS runtime error handling circuitry 208.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices, and DVD drives.

Machine executable instructions 632, which may be implemented by the machine readable instructions of FIGS. 3-5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a microprocessor 700. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 3-5.

The cores 702 may communicate by an example bus 704. In some examples, the bus 704 may implement a communication bus to effectuate communication associated with one(s) of the cores 702. For example, the bus 704 may implement at least one of an Inter-Integrated Circuit (I2C) bus, a Serial Peripheral Interface (SPI) bus, a PCI bus, or a PCIe bus. Additionally or alternatively, the bus 704 may implement any other type of computing or electrical bus. The cores 702 may access data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 720, and an example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The bus 720 may implement at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowcharts of FIGS. 3-5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowcharts of FIGS. 3-5. In particular, the FPGA 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowcharts of FIGS. 3-5. As such, the FPGA circuitry 800 may be structured to effectively instantiate some or all of the machine readable instructions of the flowcharts of FIGS. 3-5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 3-5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to access and/or output data to/from example configuration circuitry 804 and/or external hardware (e.g., external hardware circuitry) 806. For example, the configuration circuitry 804 may implement interface circuitry that may access machine readable instructions to configure the FPGA circuitry 800, or portion(s) thereof. In some such examples, the configuration circuitry 804 may access the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIGS. 3-5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowcharts of FIGS. 3-5 may be executed by one or more of the cores 702 of FIG. 7 and a second portion of the machine readable instructions represented by the flowcharts of FIGS. 3-5 may be executed by the FPGA circuitry 800 of FIG. 8.

In some examples, the processor circuitry 612 of FIG. 6 may be in one or more packages. For example, the processor circuitry 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that increase memory error handling accuracy. The disclosed systems, methods, apparatus, and articles of manufacture improve the accuracy and cost effectiveness of memory management error handling in computing devices by implementing error handling processes in the baseboard management controller and/or in system BIOS. Additionally, accuracy of tracking memory errors is increased because the tracking is performed on a per-bank level (or even a per-row level if such an implementation is warranted) instead of on a per-rank level. Furthermore, the rate of errors per memory bank is tracked to account for error trends against a timeline instead of just an absolute count without any knowledge of the timeframe involved with the count. The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent. Further examples and combinations thereof include the following:

Example methods, apparatus, systems, and articles of manufacture to increase memory error handling accuracy are disclosed herein. Further examples and combinations thereof include the following: Example 1 includes an apparatus comprising processor circuitry including one or more of at least one of a central processor unit, a graphics processor unit or a digital signal processor, the at least one of the central processor unit, the graphics processor unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or an Application Specific Integrated Circuitry (ASIC) including logic gate circuitry to perform one or more third operations, the processor circuitry to perform at least one of the one or more first operations, the one or more second operations or the one or more third operations to instantiate setting a corrected error threshold value for a memory rank, recording, in a corrected error bank record memory structure, corrected errors for memory banks in the memory rank, maintaining, in the corrected error bank record memory structure, counts of the corrected errors for the memory banks, and notifying runtime error handling circuitry in response to at least one of the counts of the corrected errors satisfying a threshold value.
Example 2 includes the apparatus of example 1, wherein the memory rank is a first memory rank, wherein the processor circuitry is to perform the at least one of the one or more first operations, the one or more second operations or the one or more third operations to instantiate reading a plurality of hardware corrected error counters, wherein the plurality of hardware corrected error counters are associated with corrected error counts for a plurality of memory ranks, the plurality of memory ranks including the first memory rank.
Example 3 includes the apparatus of example 2, wherein the processor circuitry is to perform the at least one of the one or more first operations, the one or more second operations or the one or more third operations to instantiate initiating the counts of the corrected errors for the memory banks in response to a combined rank corrected error status indicating at least one of the corrected errors has occurred in at least one of the plurality of memory ranks.
Example 4 includes the apparatus of example 1, wherein the processor circuitry is to perform the at least one of the one or more first operations, the one or more second operations or the one or more third operations to instantiate calculating a corrected error rate for ones of the memory banks, and sending an interrupt to the runtime error handling circuitry in response to the corrected error rate satisfying a corrected error rate threshold value.
Example 5 includes the apparatus of example 4, wherein the processor circuitry is to perform the at least one of the one or more first operations, the one or more second operations or the one or more third operations to instantiate initiating at least one RAS action in response to the runtime error handling circuitry receiving the interrupt.
Example 6 includes the apparatus of example 1, wherein at least a portion of the runtime error handling circuitry is in base management controller circuitry.
Example 7 includes the apparatus of example 1, wherein at least a portion of the runtime error handling circuitry is controlled by a basic input/output system (BIOS) at runtime.
Example 8 includes the apparatus of example 1, wherein the processor circuitry is to perform the at least one of the one or more first operations, the one or more second operations or the one or more third operations to instantiate notifying an operating system kernel error handling procedure of an initiation of a reliability, availability, and serviceability (RAS) action.
Example 9 includes the apparatus of example 1, wherein the threshold value is set to one.
Example 10 includes a non-transitory computer-readable storage medium comprising instructions that, when executed, cause one or more processors to at least set a corrected error (CE) threshold value for a first memory rank of a plurality of memory ranks, record, in a corrected error bank record memory structure, corrected errors for a plurality of memory banks in the first memory rank, maintain, in the corrected error bank record memory structure, counts of the corrected errors for the memory banks, and notify runtime error handling circuitry in response to at least one of the counts of the corrected errors satisfying a threshold value.
Example 11 includes the non-transitory computer-readable storage medium of example 10, wherein the instructions, when executed, cause the one or more processors to at least read a plurality of hardware corrected error counters, wherein one of the hardware corrected error counters is associated with a corrected error count for one of a plurality of memory ranks, the plurality of memory ranks including the first memory rank.
Example 12 includes the non-transitory computer-readable storage medium of example 10, wherein the instructions, when executed, cause the one or more processors to at least initiate the counts of the corrected errors for the memory banks in response to a combined rank corrected error status indicating at least one of the corrected errors has occurred in at least one of the plurality of memory ranks.
Example 13 includes the non-transitory computer-readable storage medium of example 10, wherein the instructions, when executed, cause the one or more processors to at least calculate corrected error rates for ones of the memory banks, and generate an interrupt in response to at least one of the corrected error rates satisfying a corrected error rate threshold value.
Example 14 includes the non-transitory computer-readable storage medium of example 13, wherein the instructions, when executed, cause the one or more processors to at least notify an operating system kernel error handling procedure of the corrected error rate threshold value.
Example 15 includes the non-transitory computer-readable storage medium of example 13, wherein the instructions, when executed, cause the one or more processors to at least initiate one reliability, availability, and serviceability (RAS) action in response to the interrupt being generated.
Example 16 includes the non-transitory computer-readable storage medium of example 10, wherein the instructions, when executed, cause the one or more processors to at least control at least a portion of the runtime error handling circuitry by a basic input/output system (BIOS) at runtime.
Example 17 includes the non-transitory computer-readable storage medium of example 10, wherein the instructions, when executed, cause the one or more processors to at least set the threshold value to one.
Example 18 includes a method, comprising setting a corrected error threshold value for a memory rank, recording, in a corrected error bank record memory structure, corrected errors for memory banks in the memory rank, maintaining, in the corrected error bank record memory structure, counts of the corrected errors for the memory banks, and notifying runtime error handling circuitry in response to at least one of the counts of the corrected errors satisfying a threshold value.
Example 19 includes the method of example 18, wherein the memory rank is a first memory rank, and further including reading a plurality of hardware corrected error counters, wherein the plurality of hardware corrected error counters are associated with corrected error counts for a plurality of memory ranks, the plurality of memory ranks including the first memory rank.
Example 20 includes the method of example 18, further including calculating corrected error rates for ones of the memory banks, and generating an interrupt in response to at least one of the corrected error rates satisfying a corrected error rate threshold value.
Example 21 includes the method of example 20, further including notifying an operating system kernel error handling procedure of the corrected error rate threshold value.
Example 22 includes the method of example 20, further including executing at least one reliability, availability, and serviceability (RAS) action in response to the interrupt being generated.
Example 23 includes the method of example 19, further including initiating the counts of the corrected errors for the memory banks in response to a combined rank corrected error status indicating at least one of the corrected errors has occurred in at least one of the plurality of memory ranks.
Example 24 includes the method of example 18, further including controlling at least a portion of the runtime error handling circuitry by a basic input/output system (BIOS) at runtime.
Example 25 includes the method of example 18, further including setting the threshold value to one.
Example 26 includes an apparatus comprising interface circuitry, instructions in the apparatus, processor circuitry to execute the instructions to manage accesses to a memory bank, and a bank corrected error counter corresponding to the memory bank, the bank corrected error counter to store a count value representing a number of corrected errors for the memory bank.
Example 27 includes the apparatus of example 26, further including a corrected error bank record memory structure manager circuitry to generate a corrected error bank record memory structure, the corrected error bank record memory structure to include the bank corrected error counter corresponding to the memory bank.
Example 28 includes the apparatus of example 27, wherein the corrected error bank record memory structure includes at least one of a bank corrected error storage element to store an address of a corrected error corresponding to the memory bank, a bank corrected error rates element to store a rate of corrected errors for the memory bank, or a bank corrected error threshold element to store a bank corrected error threshold value.
Example 29 includes the apparatus of example 26, further including runtime error handling circuitry to perform a reliability, availability, and serviceability (RAS) action in response to the count value in the bank corrected error counter satisfying a bank corrected error threshold value.
Example 30 includes the apparatus of example 29, wherein the runtime error handling circuitry is to perform the RAS action by replacing the memory bank with a second memory bank (e.g., a spare memory bank).

The following claims are hereby incorporated into this Detailed Description by this reference, with each claim standing on its own as a separate embodiment of the present disclosure.

1. An apparatus comprising:
programmable circuitry including one or more of:
at least one of a central processor unit, a graphics processor unit or a digital signal processor, the at least one of the central processor unit, the graphics processor unit or the digital signal processor having control circuitry to control data movement within the programmable circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including first logic gate circuitry, a plurality of configurable interconnections, and storage circuitry, the first logic gate circuitry and interconnections to perform one or more second operations, the storage circuitry to store a result of the one or more second operations; or
an Application Specific Integrated Circuitry (ASIC) including second logic gate circuitry to perform one or more third operations;
the programmable circuitry to perform at least one of the one or more first operations, the one or more second operations or the one or more third operations to instantiate:
setting a corrected error threshold value for a memory rank;
recording, in a corrected error bank record memory structure, corrected errors for memory banks in the memory rank;
maintaining, in the corrected error bank record memory structure, counts of the corrected errors for the memory banks; and
notifying runtime error handling circuitry after at least one of the counts of the corrected errors satisfying a threshold value.

2. The apparatus of claim 1, wherein the memory rank is a first memory rank, wherein the programmable circuitry is to perform the at least one of the one or more first operations, the one or more second operations or the one or more third operations to instantiate:
reading a plurality of hardware corrected error counters, wherein the plurality of hardware corrected error counters are associated with corrected error counts for a plurality of memory ranks, the plurality of memory ranks including the first memory rank.

3. The apparatus of claim 2, wherein the programmable circuitry is to perform the at least one of the one or more first operations, the one or more second operations or the one or more third operations to instantiate:
initiating the counts of the corrected errors for the memory banks after a combined rank corrected error status indicates at least one of the corrected errors has occurred in at least one of the plurality of memory ranks.

4. The apparatus of claim 1, wherein the programmable circuitry is to perform the at least one of the one or more first operations, the one or more second operations or the one or more third operations to instantiate:
calculating a corrected error rate for ones of the memory banks; and
sending an interrupt to the runtime error handling circuitry after the corrected error rate satisfies a corrected error rate threshold value.

5. The apparatus of claim 4, wherein the programmable circuitry is to perform the at least one of the one or more first operations, the one or more second operations or the one or more third operations to instantiate:
initiating a RAS action after the runtime error handling circuitry receives the interrupt.

6. The apparatus of claim 1, wherein at least a portion of the runtime error handling circuitry is in base management controller circuitry.

7. The apparatus of claim 1, wherein at least a portion of the runtime error handling circuitry is controlled by a basic input/output system (BIOS) at runtime.

8. The apparatus of claim 1, wherein the programmable circuitry is to perform the at least one of the one or more first operations, the one or more second operations or the one or more third operations to instantiate:
notifying an operating system kernel error handling procedure of an initiation of a reliability, availability, and serviceability (RAS) action.

9. The apparatus of claim 1, wherein the threshold value is set to one.

10. A non-transitory computer-readable storage medium comprising instructions to cause programmable circuitry to at least:
set a corrected error (CE) threshold value for a first memory rank of a plurality of memory ranks;
record, in a corrected error bank record memory structure, corrected errors for a plurality of memory banks in the first memory rank;
maintain, in the corrected error bank record memory structure, counts of the corrected errors for the memory banks; and
notify runtime error handling circuitry after at least one of the counts of the corrected errors satisfies a threshold value.

11. The non-transitory computer-readable storage medium of claim 10, wherein the instructions are to cause the programmable circuitry to at least:
read a plurality of hardware corrected error counters, wherein one of the hardware corrected error counters is associated with a corrected error count for one of the plurality of memory ranks, the plurality of memory ranks including the first memory rank.

12. The non-transitory computer-readable storage medium of claim 10, wherein the instructions are to cause the programmable circuitry to at least:
initiate the counts of the corrected errors for the memory banks after a combined rank corrected error status indicates at least one of the corrected errors has occurred in at least one of the plurality of memory ranks.

13. The non-transitory computer-readable storage medium of claim 10, wherein the instructions are to cause the programmable circuitry to at least:
calculate corrected error rates for ones of the memory banks; and
generate an interrupt after at least one of the corrected error rates satisfies a corrected error rate threshold value.

14. The non-transitory computer-readable storage medium of claim 13, wherein the instructions are to cause the programmable circuitry to notify an operating system kernel error handling procedure of the corrected error rate threshold value.

15. The non-transitory computer-readable storage medium of claim 13, wherein the instructions are to cause the programmable circuitry to initiate one reliability, availability, and serviceability (RAS) action after the interrupt.

16. The non-transitory computer-readable storage medium of claim 10, wherein the instructions are to cause the programmable circuitry to at least:
control at least a portion of the runtime error handling circuitry by a basic input/output system (BIOS) at runtime.

17. The non-transitory computer-readable storage medium of claim 10, wherein the instructions are to cause the programmable circuitry to set the threshold value to one.

18. A method, comprising:
setting a corrected error threshold value for a memory rank;
recording, in a corrected error bank record memory structure, corrected errors for memory banks in the memory rank;
maintaining, in the corrected error bank record memory structure, counts of the corrected errors for the memory banks; and
notifying, by executing an instruction with programmable circuitry, runtime error handling circuitry after at least one of the counts of the corrected errors satisfies a threshold value.

19. The method of claim 18, wherein the memory rank is a first memory rank, and further including:
reading a plurality of hardware corrected error counters, wherein the plurality of hardware corrected error counters are associated with corrected error counts for a plurality of memory ranks, the plurality of memory ranks including the first memory rank.

20. The method of claim 18, further including:
calculating corrected error rates for ones of the memory banks; and
generating an interrupt after at least one of the corrected error rates satisfies a corrected error rate threshold value.

21-30. (canceled)
